(19) United States
(12) Patent Application Publication
(10) Pub. No.: US 2024/0365249 A1
(43) Pub. Date: Oct. 31, 2024

(54) METHOD FOR DYNAMICALLY ALLOCATING TRANSMITTING POWERS TO MULTIPLE TRANSMITTING MODULES OF RADIO MODULE AND ASSOCIATED RADIO MODULE

(71) Applicant: MEDIATEK INC., Hsin-Chu (TW)

(72) Inventors: Shihao Ju, San Jose, CA (US); Yi-Hsuan Lin, Hsinchu City (TW)

(73) Assignee: MEDIATEK INC., Hsin-Chu (TW)

(21) Appl. No.: 18/646,795

(22) Filed: Apr. 26, 2024

Related U.S. Application Data
(60) Provisional application No. 63/461,931, filed on Apr. 26, 2023.

(51) Int. Cl. H04W 52/34

(52) U.S. Cl. CPC H04W 52/34

(57) ABSTRACT

A method for dynamically allocating transmitting (TX) powers to multiple TX modules of a radio module includes: for each of the multiple TX modules: mapping a radio frequency (RF) exposure limit to a TX power limit; obtaining a first TX power limit corresponding a first time interval and a second TX power limit corresponding a second time interval, wherein the first time interval is earlier than the second time interval; in response to a TX power corresponding to the first time interval being smaller than the first TX power limit, calculating and storing a value of an unused TX power corresponding the first time interval in at least one power pool within a memory; and in response to a TX power corresponding to the second time interval being larger than the second TX power limit, obtaining the value of the unused TX power from the at least one power pool.

### CROSS REFERENCE TO RELATED APPLICATIONS

This application claims the benefit of U.S. Provisional Application No. 63/461,931, filed on Apr. 26, 2023. The content of the application is incorporated herein by reference.

### BACKGROUND

The present invention is related to radio frequency (RF) technology, and more particularly, to a method for dynamically allocating transmitting (TX) powers to multiple TX modules of a radio module and an associated radio module.

Nowadays, the RF technology has often appeared in a user equipment (UE; such as a mobile phone). However, excessive RF exposure may cause harm to human body. As a result, officials of different countries (e.g. federal communications commission (FCC) of USA, innovation, science, and economic development (ISED) of Canada, and conformite europeenne (CE) of Europe) regulate a time-averaged RF exposure limit to limit a time-averaged RF exposure of a radio module in the UE. For example, in response to a frequency band of the radio module being smaller than 6 GHZ, the time-averaged RF exposure will be quantified with a time-averaged specific absorption rate (SAR), and in response to the frequency band of the radio module being not smaller than 6 GHZ, the time-averaged RF exposure will be quantified with a time-averaged power density (PD). In addition, since the time-averaged RF exposure will be proportional to a TX power of the radio module, the time-averaged RF exposure can meet the time-averaged RF exposure limit by controlling the TX power.

For simultaneous multi-radio access technology (multi-RAT) transmission (e.g. 2G, 3G, 4G, FR1, FR2, wireless fidelity (Wi-Fi), and Bluetooth (BT)), the officials regulate that a total exposure ratio (TER) must be less than or equal to 1 (i.e. TER≤1). How to properly allocate TX powers of multiple TX modules of a radio module in the UE has become an important issue. In order to achieve best data throughput and best network capacity efficiency while being compliant to the regulated RF exposure limit, a novel method for dynamically allocating TX powers to multiple TX modules of a radio module and an associated radio module is urgently needed.

### SUMMARY

It is therefore one of the objectives of the present invention to provide a method for dynamically allocating TX powers to multiple TX modules of a radio module and an associated radio module, to address the above-mentioned issues.

According to an embodiment of the present invention, a method for dynamically allocating TX powers to multiple TX modules of a radio module is provided. The method comprises: for each of the multiple TX modules: mapping an RF exposure limit to a TX power limit; obtaining a first TX power limit corresponding a first time interval and a second TX power limit corresponding a second time interval from the TX power limit, wherein the first time interval is earlier than the second time interval; in response to a TX power corresponding to the first time interval being smaller than the first TX power limit, calculating an unused TX power corresponding the first time interval and storing a value of the unused TX power in at least one power pool within a memory; and in response to a TX power corresponding to the second time interval being larger than the second TX power limit, obtaining the value of the unused TX power from the at least one power pool.

According to an embodiment of the present invention, a radio module for adjusting TX powers of multiple TX modules is provided. The radio module is arranged to: for each of the multiple TX modules: map an RF exposure limit to a TX power limit; obtain a first TX power limit corresponding a first time interval and a second TX power limit corresponding a second time interval from the TX power limit, wherein the first time interval is earlier than the second time interval; in response to a TX power corresponding to the first time interval being smaller than the first TX power limit, calculate an unused TX power corresponding the first time interval and store a value of the unused TX power in at least one power pool within a memory; and in response to a TX power corresponding to the second time interval being larger than the second TX power limit, obtain the value of the unused TX power from the at least one power pool.

One of the benefits of the present invention is that, by the method of the present invention and an associated radio module, under a condition that a TX module performs a TX operation with an unused TX power in a first time interval, a value of the unused TX power may be stored in at least one power pool. In a second time interval later than the first time interval, if the same TX module and/or a different TX module perform another TX operation with a TX power higher than a TX power limit, the value of the unused TX power may be accessed from the at least one power pool for increasing the TX power limit. In this way, better data throughput and better network capacity efficiency can be achieved when multiple TX modules of a radio module perform TX operations at the same time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an allocation scheme of TX powers of multiple TX modules performed through a power pool according to an embodiment of the present invention.

FIG. 3 is a diagram illustrating a normalization scheme of unused TX powers of multiple TX modules according to an embodiment of the present invention.

FIG. 4 is a diagram illustrating a clear scheme for a power pool according to an embodiment of the present invention.

FIG. 5 is a diagram illustrating an example of RF exposure compliance violation according to an embodiment of the present invention.

FIG. 6 is a flow chart of a method for dynamically allocating TX powers to multiple TX modules of a radio module according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

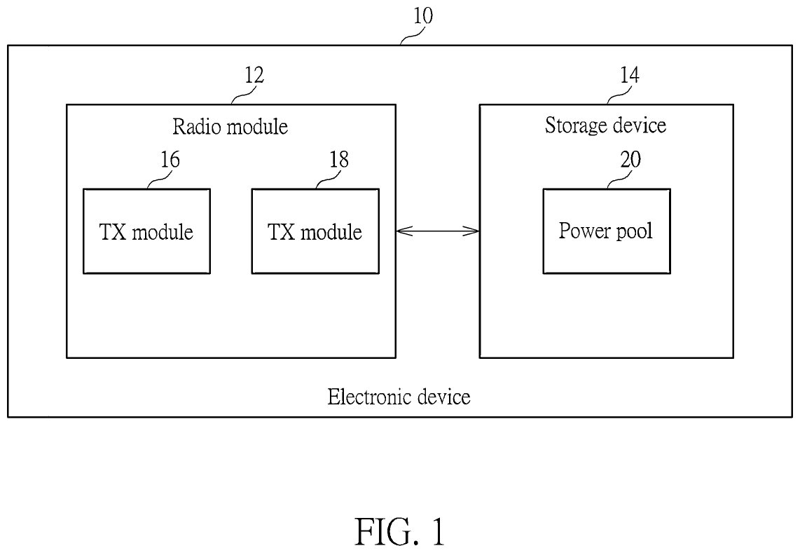

FIG. 1 is a diagram illustrating an electronic device 10 according to an embodiment of the present invention. By way of example, but not limitation, the electronic device 10 may be a portable device such as a smartphone, a wearable device, or a tablet. As shown in FIG. 1, the electronic device 10 may include a radio module 12 and a storage device (e.g., a memory) 14, wherein the radio module 12 may include multiple transmitting (TX) modules 16 and 18, and the storage device 14 may include at least one power pool (e.g., a power pool 20), wherein the power pool 20 may be shared between the TX modules 16 and 18. For example, the TX modules 16 and 18 may use different power amplifiers and different antennas in the radio module 12. The radio module 12 may include communication circuits corresponding to sub-6, millimeter wave (mmWave), Wi-Fi, BT, Zigbee, global positioning system (GPS), vehicle to everything (V2X), and/or non-terrestrial networks (NTN), but the present invention is not limited thereto. For better comprehension, in this embodiment, the number of the at least one power pool is one (i.e., the power pool 20), but the present invention is not limited thereto. In some embodiments, the number of the at least one power pool can be more than one, depending on the regulations on simultaneous transmission from multiple TX modules and particular TX module placement.

The radio module 12 may further include circuits arranged to dynamically allocate TX powers of the TX modules 16 and 18 through unused TX powers recorded (e.g., stored) in the power pool 20. Specifically, under a condition that a TX time of each of the TX modules 16 and 18 is separated into multiple time intervals, the radio module 12 may calculate a value of an unused TX power corresponding to each time interval for each of the TX modules 16 and 18, and store the value of the unused TX power into the power pool 20 for TX power allocation of other time intervals. This is for illustration only, and the present invention is not limited thereto. In some embodiments, the radio module 12 may include more than two TX modules, and may also dynamically allocate TX powers of those TX modules through the power pool 20. In some embodiments, the electronic device 10 may further include another radio module, and the another radio module may also include multiple TX modules, wherein any of the radio module 12 and the another radio module may dynamically allocate TX powers of the TX modules 16 and 18 in the radio module 12 and TX powers of the multiple TX modules in the another radio module through the power pool 20. These alternative designs all fall within the scope of the present invention.

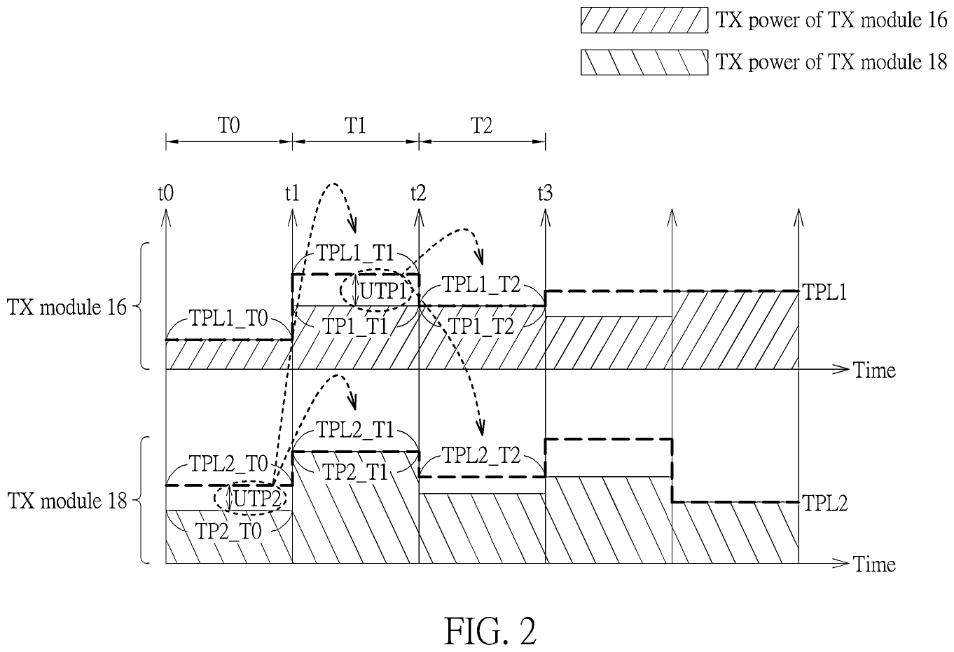

In detail, please refer to FIG. 2. FIG. 2 is a diagram illustrating an allocation scheme of TX powers of the TX modules 16 and 18 performed through the power pool 20 according to an embodiment of the present invention. The radio module 12 may be arranged to receive a time-averaged RF exposure limit regulated by officials (for brevity, hereinafter denoted by “RF exposure limit”), wherein the RF exposure limit is proportional to a TX power of each of the TX modules 16 and 18. For the TX module 16, the radio module 12 may map the RF exposure limit to a TX power limit TPL1 of the TX module 16. Specifically, the RF exposure limit may be a specific absorption rate (SAR) limit, and the radio module 108 may utilize a test or a simulation to find the TX power limit TPL1 mapped to the SAR limit. However, this is for illustration only, and the present invention is not limited thereto. In some embodiments, a user may directly utilize the test or the simulation to find the TX power limit TPL1. That is, the RF exposure limit may also be mapped to the TX power limit TPL1 of the TX module 16 directly by the user.

In addition, since configurations of the TX module 16 are different from that of the TX module 18, the TX power limit TPL1 of the TX module 16 is also different from a TX power limit TPL2 of the TX module 18. Similarly, the radio module 12 may map the RF exposure limit to the TX power limit TPL2 of the TX module 18. In some embodiments, the user may directly utilize the test or the simulation to find the TX power limit TPL2. That is, the RF exposure limit may also be mapped to the TX power limit TPL2 of the TX module 18 directly by the user.

As shown in FIG. 2, a TX time of each of the TX modules 16 and 18 may be divided into multiple time intervals, such as a time interval TO from a time point t0 to a time point t1, a time interval T1 from the time point t1 to a time point t2, a time interval T2 from the time point t2 to a time point t3, and so on, wherein each of the TX modules 16 and 18 may perform a TX operation in each time interval. The radio module 12 may obtain a TX power limit corresponding to each time interval from the TX power limit TPL1/TPL2 by performing a fixed back-off operation or executing a time average algorithm, and may record (e.g., store) a value of an unused TX power of the each time interval in the power pool 20 for subsequent TX operations, wherein the unused TX power is a difference between the TX power limit corresponding to the each time interval and the TX power corresponding to the each time interval. For better comprehension, for the TX module 18, the radio module 12 may obtain a TX power limit TPL2_T0 corresponding to the time interval TO, a TX power limit TPL2_T1 corresponding to the time interval T1, a TX power limit TPL2_T2 corresponding to the time interval T2, and so on. For the TX module 16, the radio module 12 may obtain a TX power limit TPL1_T0 corresponding to the time interval TO, a TX power limit TPL1_T1 corresponding to the time interval T1, a TX power limit TPL1_T2 corresponding to the time interval T2, and so on.

For example, for the time interval TO, since a TX power corresponding to the time interval TO of the TX module 18 (denoted by “TP2_T0”) is smaller than the TX power limit TPL2_T0 of the TX module 18, the radio module 12 may calculate an unused TX power UTP2 according to the TX power limit TPL2_T0 and the TX power TP2_T0, and store a value of the unused TX power UTP2 in the power pool 20. When there is a need, the radio module 12 may obtain (e.g. access) the value of the unused TX power UTP2 from the power pool 20 for power allocation of each of the TX modules 16 and 18 in subsequent time intervals. It is assumed that a TX power corresponding to the time interval T1 of the TX module 18 (denoted by “TP2_T1”) is initially larger than the TX power limit TPL2_T1 of the TX module 18. Under this condition, the radio module 12 may obtain the value of the unused TX power UTP2 from the power pool 20 to update (e.g., increase) the TX power limit TPL2_T1 to be greater than or equal to the TX power TP2_T1 (e.g., the TX power limit TPL2_T1 is substantially equal to the TX power TP2_T1 in FIG. 2).

For another example, for the time interval T1, since a TX power corresponding to the time interval T1 of the TX module 16 (denoted by “TP1_T1”) is smaller than the TX power limit TPL1_T1 of the TX module 16, the radio module 12 may calculate an unused TX power UTP1 according to the TX power limit TPL1_T1 and the TX power TP1_T1, and store a value of the unused TX power UTP1 in the power pool 20. When there is a need, the radio module 12 may obtain the value of the unused TX power UTP1 from the power pool 20 for power allocation of each of the TX modules 16 and 18 in subsequent time intervals. It is assumed that a TX power corresponding to the time interval T2 of the TX module 16 (denoted by “TP1_T2”) is initially larger than the TX power limit TPL1_T2 of the TX module 16. Under this condition, the radio module 12 may obtain the value of the unused TX power UTP1 from the power pool 20 to update (e.g., increase) the TX power limit TPL1_T2 to be greater than or equal to the TX power TP1_T2 (e.g., the TX power limit TPL1_T2 is substantially equal to the TX power TP1_T2 in FIG. 2).

Since those skilled in the art can easily understand TX power allocation operations for subsequent time intervals, further descriptions are not repeated in detail here for brevity.

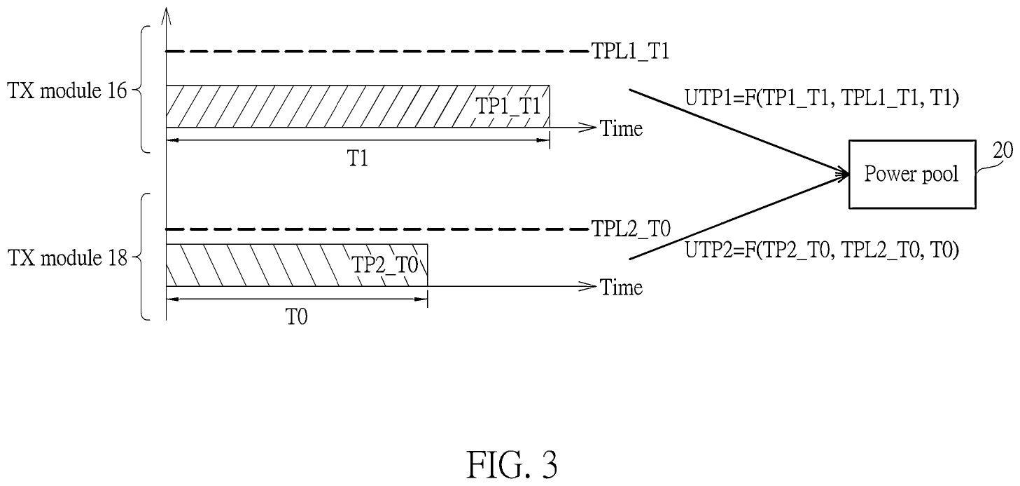

FIG. 3 is a diagram illustrating a normalization scheme of unused TX powers of the TX modules 16 and 18 according to an embodiment of the present invention. Before the value of the unused TX power is stored in the power pool 20, a normalization operation should be performed. Specifically, the radio module 12 may perform the normalization operation by calculating the value of the unused TX power according to a function of a corresponding TX power, a corresponding TX power limit, and a corresponding time interval. For example, for the unused TX power UTP1 of the TX module 16 and the unused TX power UTP2 of the TX module 18, the radio module 12 may perform the normalization operation by calculating the value of the unused TX power UTP1 according to a function of the TX power TP1_T1, the TX power limit TPL1_T1, and the time interval T1 (i.e., UTP1=F(TP1_T1, TPL1_T1, T1)), and calculating the value of the unused TX power UTP2 according to a function of the TX power TP2_T0, the TX power limit TPL2_T0, and the time interval TO (i.e., UTP2=F(TP2_T0, TPL2_T0, T0)), and then store values of the unused TX powers UTP1 and UTP2 in the power pool 20.

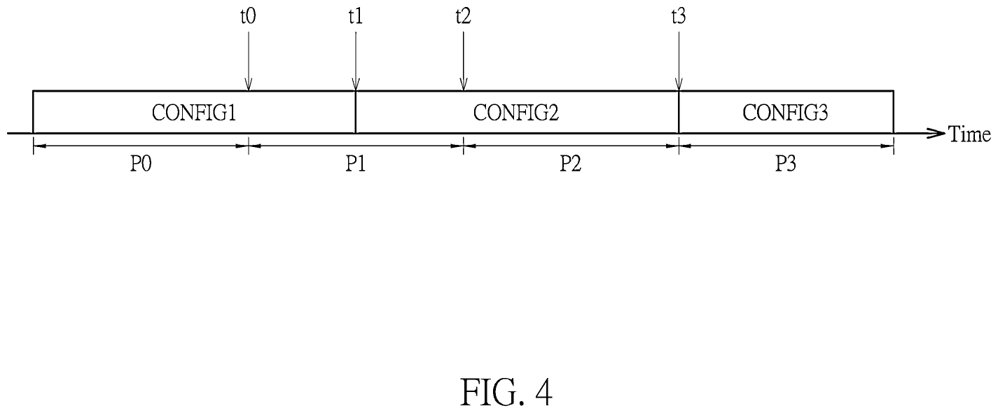

In order to prevent a total unused TX power (indicated by values stored in the power pool 20) from being larger than the RF exposure limit, the radio module 12 may perform a clear operation upon the power pool 20 periodically and/or aperiodically. FIG. 4 is a diagram illustrating a clear scheme for the power pool 20 according to an embodiment of the present invention, wherein the clear scheme may include a periodic clear scheme and/or an aperiodic clear scheme. For the periodic clear scheme, the power pool 20 may be cleared periodically according to a clear frequency, wherein the clear frequency may be determined according to an average time window of RF exposure defined by regulations and specifications. As shown in FIG. 4, clear time periods P0-P3 may be obtained according to the clear frequency, and the clear operation may be performed at time points between two of the clear time periods P0-P3 (e.g., time points t0, t2, and t3). For the aperiodic clear scheme, the power pool 20 may be cleared aperiodically in response to a configuration of each of the TX modules 16 and 18 changing (e.g., each of the TX modules 16 and 18 enters a sleep mode or a flight mode, or an exposure condition index switching event happens for each of the TX modules 16 and 18). For example, the configuration of each of the TX modules 16 and 18 may change from a configuration CONFIG. 1 to a configuration CONFIG. 2 at a time point t1, and change from the configuration CONFIG. 2 to a configuration CONFIG. 3 at the time point t3, wherein the clear operation may be performed at the time points t1 and t3. It should be noted that a combination or one of the periodic clear scheme and the aperiodic clear scheme can be applied to the power pool 20, depending upon actual design requirements.

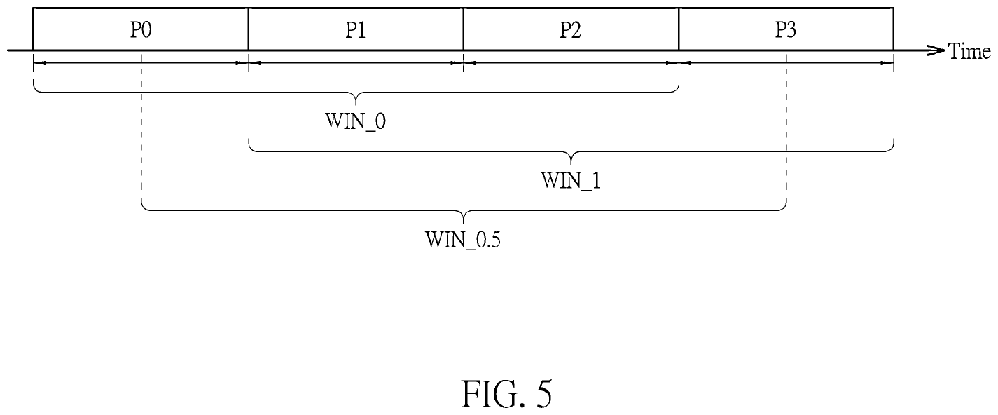

FIG. 5 is a diagram illustrating an example of RF exposure compliance violation according to an embodiment of the present invention. As shown in FIG. 5, a time period of an average time window of the RF exposure may be three times a clear time period. For example, an average time window WIN_0 covers the clear time periods P0-P2, an average time window WIN_1 covers the clear time periods P1-P3, and an average time window WIN_0.5 covers at least one portion (e.g., half) of the clear time period P0, all of the clear time period P1, all of the clear time period P2, and at least one portion (e.g., half) of the clear time period P3. For the average time windows WIN_0 and WIN_1, since a start time point and an end time point of the time period of the RF exposure measurement align with a start time point and an end time point of the clear time period, respectively, there is no risk of exceeding the RF exposure limit. However, for the average time window WIN_0.5, the start time point and the end time point of the time period of the RF exposure measurement do not align with the start time point and the end time point of the clear time period, respectively. If a TX power corresponding to a part of the clear time period P0 that is not covered by the average time window WIN_0.5 is much lower than the TX power limit (i.e., a large value of the unused TX power will be stored in the power pool 20 for the part of the clear time period P0), and all of the large value of the unused TX power is accessed from the power pool 20 to increase the corresponding TX power limit for another part of the clear time period P0 that is covered by the average time window WIN_0.5, a TX power corresponding to the three time periods included in the average time window WIN_0.5 may exceed a TX power that the three time periods can afford, which results in a risk of exceeding the RF exposure limit.

In order to address this issue, the radio module 12 may be further arranged to perform a protection operation upon the TX power limit TPL1/TPL2 for preventing the RF exposure limit from being exceeded when the power allocation is performed through the power pool 20. More particularly, the protection operation may be performed upon a TX power limit corresponding to a time interval that is updated by obtaining the value of the unused TX power from the power pool 20 (e.g., the TX power limit TPL2_T1 and the TX power limit TPL1_T2). For example, the radio module 12 may reduce a protection margin from the TX power limit TPL1/TPL2 (more particularly, the TX power limit TPL2_T1 and the TX power limit TPL1_T2) to ensure that an average TX power at any moment will not exceed the TX power limit TPL1/TPL2, wherein the protection margin may be calculated according to the clear time period and the average time window. However, the present invention is not limited thereto. Different types of protection mechanisms may be applied to the power allocation method proposed by the present invention.

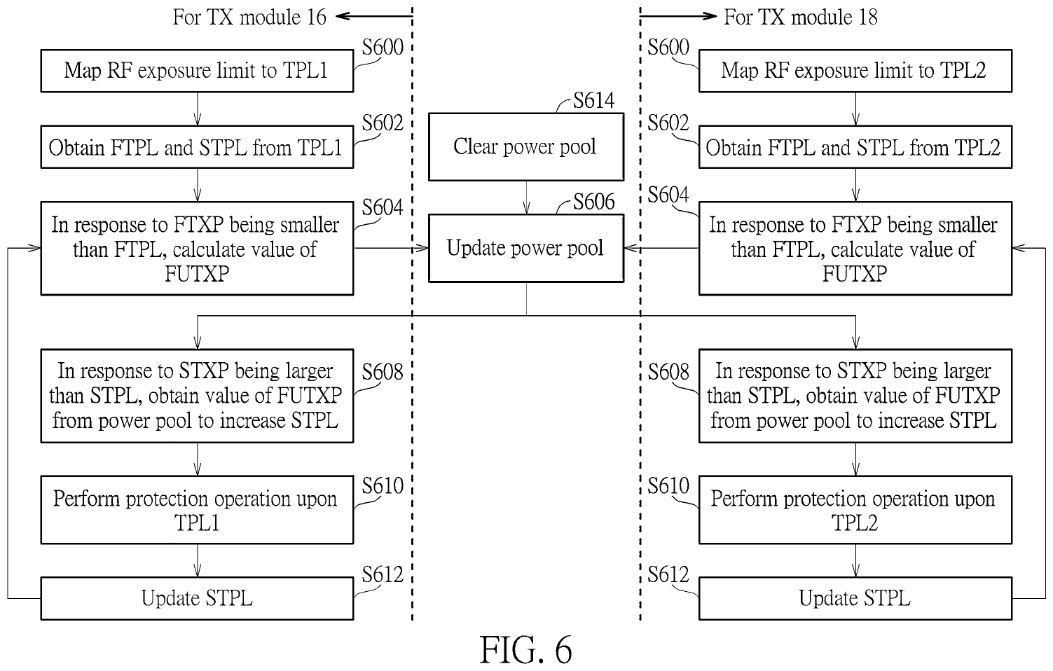

FIG. 6 is a flow chart of a method for dynamically allocating TX powers to multiple TX modules of a radio module according to an embodiment of the present invention. Provided that the result is substantially the same, the steps are not required to be executed in the exact order shown in FIG. 6. For example, the method shown in FIG. 6 may be employed by the radio module 12 shown in FIG. 1.

In Step S600, for the TX module 16, the RF exposure limit (e.g., the SAR limit) is mapped to the TX power limit TPL1. Similarly, for the TX module 18, the RF exposure limit is mapped to the TX power limit TPL2.

In Step S602, a first TX power limit corresponding to a first time interval (labeled as “FTPL” in FIG. 6 for brevity) and a second TX power limit corresponding to a second time interval (labeled as “STPL” in FIG. 6 for brevity) are obtained from the TX power limit TPL1/TPL2 by performing a fixed back-off operation or executing a time average algorithm, wherein the first time interval is earlier than the second time interval. Take the embodiment shown in FIG. 2 as an example. The first time interval may be the time interval TO, the first TX power limit may be the TX power limit TPL2_T0 of the TX module 18, the second time interval may be the time interval T1, and the second TX power limit may be the TX power limit TPL2_T1 of the TX module 18. For another example, the first time interval may be the time interval T1, the first TX power limit may be the TX power limit TPL1_T1 of the TX module 16, the second time interval may be the time interval T2, and the second TX power limit may be the TX power limit TPL1_T2 of the TX module 16.

In Step S604, for each of the TX modules 16 and 18, in response to a TX power corresponding to the first time interval (e.g., the TX power TP2_T0/TP1_T1; labeled as “FTXP” in FIG. 6 for brevity) being smaller than the first TX power limit (e.g., the TX power limit TPL2_T0/TPL1_T1), a value of an unused TX power corresponding to the first time interval (e.g., the unused TX power UTP2/UTP1; labeled as “FUTXP” in FIG. 6 for brevity) is calculated.

In Step S606, the value of the unused TX power is stored in the power pool 20 to update the power pool 20.

In Step S608, for each of the TX modules 16 and 18, in response to a TX power corresponding to the second time interval (e.g., the TX power TP2_T1/TP1_T2; labeled as “STXP” in FIG. 6 for brevity) being larger than the second TX power limit (e.g., the TX power limit TPL2_T1/TPL1_T2), the value of the unused TX power is obtained (e.g., accessed) from the power pool 20 to increase the second TX power limit.

In Step S610, a protection operation is performed upon the TX power limit TPL1/TPL2 (more particularly, the second TX power limit) for preventing the RF exposure limit from being exceeded when the power allocation is performed through the power pool 20. For example, a protection margin may be reduced from the TX power limit TPL1/TPL2 (more particularly, the second TX power limit) to ensure that an average TX power at any moment will not exceed the TX power limit TPL1/TPL2.

In Step S612, for each of the TX modules 16 and 18, after the protection operation is performed upon the TX power limit TPL1/TPL2 (more particularly, the second TX power limit), the second TX power limit corresponding to the second time interval (labeled as “STPL” in FIG. 6 for brevity) is updated.

In Step S614, the power pool 20 is cleared periodically and/or aperiodically.

Since a person skilled in the pertinent art can readily understand details of the steps after reading above paragraphs directed to the radio module 12 shown in FIG. 1, further descriptions are omitted here for brevity.

In summary, by the method of the present invention and an associated radio module, under a condition that a TX module performs a TX operation with an unused TX power in a first time interval, a value of the unused TX power may be stored in at least one power pool. In a second time interval later than the first time interval, if the same TX module and/or a different TX module perform another TX operation with a TX power higher than a TX power limit, the value of the unused TX power may be accessed from the at least one power pool for increasing the TX power limit. In this way, better data throughput and better network capacity efficiency can be achieved when multiple TX modules of a radio module perform TX operations at the same time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for dynamically allocating transmitting (TX) powers to multiple TX modules of a radio module, comprising:
for each of the multiple TX modules:
mapping a radio frequency (RF) exposure limit to a TX power limit;
obtaining a first TX power limit corresponding a first time interval and a second TX power limit corresponding a second time interval from the TX power limit, wherein the first time interval is earlier than the second time interval;
in response to a TX power corresponding to the first time interval being smaller than the first TX power limit, calculating an unused TX power corresponding the first time interval and storing a value of the unused TX power in at least one power pool within a memory; and
in response to a TX power corresponding to the second time interval being larger than the second TX power limit, obtaining the value of the unused TX power from the at least one power pool.

2. The method of claim 1, wherein the at least one power pool is shared between the multiple TX modules.

3. The method of claim 1, wherein the value of the unused TX power is calculated according to a function of the TX power corresponding to the first time interval, the first TX power limit, and the first time interval.

4. The method of claim 1, further comprising:
periodically clearing the at least one power pool according to a clear frequency.

5. The method of claim 1, further comprising:
aperiodically clearing the at least one power pool in response to a configuration of the each of the multiple TX modules changing.

6. The method of claim 1, wherein the step of in response to the TX power corresponding to the second time interval being larger than the second TX power limit, obtaining the value of the unused TX power from the at least one power pool comprises:
increasing the second TX power limit by the unused TX power.

7. The method of claim 1, further comprising:
performing a protection operation upon the second TX power limit.

8. The method of claim 7, wherein the step of performing the protection operation upon the second TX power limit comprising:
reducing the second TX power limit by a protection margin.

9. The method of claim 7, further comprising:
after the protection operation is performed upon the second TX power limit, updating the second TX power limit.

10. A radio module for adjusting transmitting (TX) powers of multiple TX modules, wherein the radio module is arranged to:
for each of the multiple TX modules:
map a radio frequency (RF) exposure limit to a TX power limit;
obtain a first TX power limit corresponding a first time interval and a second TX power limit corresponding a second time interval from the TX power limit, wherein the first time interval is earlier than the second time interval;
in response to a TX power corresponding to the first time interval being smaller than the first TX power limit, calculate an unused TX power corresponding the first time interval and store a value of the unused TX power in at least one power pool within a memory; and
in response to a TX power corresponding to the second time interval being larger than the second TX power limit, obtain the value of the unused TX power from the at least one power pool.

11. The radio module of claim 10, wherein the at least one power pool is shared between the multiple TX modules.

12. The radio module of claim 10, wherein the value of the unused TX power is calculated according to a function of the TX power corresponding to the first time interval, the first TX power limit, and the first time interval.

13. The radio module of claim 10, wherein the radio module is further arranged to periodically clear the at least one power pool according to a clear frequency.

14. The radio module of claim 10, wherein the radio module is further arranged to aperiodically clear the at least one power pool in response to a configuration of the each of the multiple TX modules changing.

15. The radio module of claim 10, wherein the radio module is further arranged to increase the second TX power limit by the unused TX power.

16. The radio module of claim 10, wherein the radio module is further arranged to perform a protection operation upon the second TX power limit.

17. The radio module of claim 16, wherein the radio module is further arranged to reduce the second TX power limit by a protection margin.

18. The radio module of claim 16, wherein after the protection operation is performed upon the second TX power limit, the radio module is further arranged to update the second TX power limit.
